(19) United States
(12) Patent Application Publication
(10) Pub. No.: US 2019/0258249 A1
(43) Pub. Date: Aug. 22, 2019

(54) APPARATUS AND METHOD FOR CONTROLLING DRIVING MODE SWITCH OF VEHICLE AND VEHICLE SYSTEM

(71) Applicants: HYUNDAI MOTOR COMPANY, Seoul (KR); KIA MOTORS CORPORATION, Seoul (KR)

(72) Inventors: Jun Soo KIM, Seoul (KR); Su Jung YOO, Incheon (KR); Dong Hwi LEE, Seongnam-si (KR)

(21) Appl. No.: 16/022,359

(22) Filed: Jun. 28, 2018

(30) Foreign Application Priority Data
Feb. 21, 2018 (KR) 10-2018-0020341

(51) Int. Cl. G05D 1/00; G05D 1/02; G01C 21/36; G06F 17/30

(52) U.S. Cl. CPC G05D 1/0061; G05D 1/0231; G05D 2201/0213; G06F 17/30241; G01C 21/36

(57) ABSTRACT

A driving mode switching control apparatus of a vehicle includes one or more processors collecting data from a map DB, a positioning system, a camera system, and a sensor system in the vehicle; analyzing the collected data to determine a reliability of each data; and designing a driving mode switching of the vehicle based on the determined result of the reliability of the each data to generate mode switching data including an information of the designed driving mode switching.

### CROSS-REFERENCE TO RELATED APPLICATION

This application is based on and claims the benefit of priority to Korean Patent Application No. 10-2018-0020341, filed on Feb. 21, 2018, in the Korean Intellectual Property Office, the disclosure of which is incorporated herein in its entirety by reference.

### TECHNICAL FIELD

The present disclosure relates to an apparatus and a method for controlling a driving mode switch of a vehicle and a vehicle system.

### BACKGROUND

In recent years, demands and requirements on an advanced driver assistance system (ADAS) and an autonomous driving system have increased. Accordingly, an amount of information on in-vehicle sensor data and a precise map increases, and thus a variety of driving convenience features is being developed based on the in-vehicle sensor data and the precise map.

However, an accuracy of the information on the sensor data and/or the precise map is poor due to an environmental condition and conditions such as constraints on sensor, and thus performance of the ADAS and the autonomous driving system is deteriorated.

Accordingly, a driving mode switching needs to be designed by taking into account that the information may be less accurate in the ADAS and the autonomous driving system.

### SUMMARY

The present disclosure has been made to solve the above-mentioned problems occurring in the prior art while advantages achieved by the prior art are maintained intact

An aspect of the present disclosure provides an apparatus and a method for controlling a driving mode switch of a vehicle and a vehicle system providing the same. The apparatus, method, and system are capable of effectively controlling a driving of a vehicle by collecting data of a precise map and a recognition sensor to determine reliability and designing a driving mode switching based on the determined result to provide driving mode switching information.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a driving mode switching control apparatus of a vehicle includes one or more processors that are configured to: collect data from a map DB, a positioning system, a camera system, and a sensor system in the vehicle, analyze the collected data to determine a reliability of each data, and design a driving mode switching of the vehicle based on the determined result of the reliability of the each data and generating mode switching data including an information of the designed driving mode switching.

The one or more processors may collect map data including a precise map and a sensor map, positioning data, line data, and obstacle data from the map DB, the positioning system, the camera system, and the sensor system.

The one or more processors may analyze an error amount between sensor data and the map data, an error accumulation duration, and regional information and determines the reliability of a precise map and a sensor map based on the analyzed result.

The one or more processors may analyze a variation of error covariance size in a tracking logic, an update cycle of sensor data, and an error accumulation amount between an estimated value and the sensor data, and determines the reliability of positioning data based on the analyzed result.

The one or more processors may analyze a reliability level of line information and an error between a forward vehicle travel route and an ego-vehicle travel route in a same traffic lane and determines the reliability of line data.

The one or more processors may determine the reliability of obstacle data based on an error amount with respect to obstacle output information of a duplicate detection area from each sensor of the sensor system and weather information.

The one or more processors may generate the mode switching data for switching a driving mode of the vehicle to a highway autonomous driving mode, a highway driving supporting mode, a traffic-lane following supporting mode, or a driver driving mode depending on the determined result of the reliability of the each data.

The one or more processors may generate the mode switching data for switching the driving mode of the vehicle to the highway autonomous driving mode when the reliability of the each data is equal to or higher than a reference value.

The one or more processors may generate the mode switching data for switching the driving mode of the vehicle to the driver driving mode when the reliability of the each data is lower than the reference value.

The one or more processors may be further configured to preprocess the collected data.

According to another aspect of the present disclosure, a driving mode switching control method of a vehicle may include collecting, by one or more processor, data from a map DB, a positioning system, a camera system, and a sensor system in the vehicle, analyzing, by the one or more processor, the collected data to determine a reliability of each data, and designing, by the one or more processor, a driving mode switching of the vehicle based on the determined result of the reliability of the each data to generate mode switching data including an information of the designed driving mode switching.

According to another aspect of the present disclosure, a vehicle system includes a driving mode switching control apparatus having one or more processors that are configured to: collect map data, positioning data, line data, and obstacle data from a map DB, a positioning system, a camera system, and a sensor system in a vehicle, analyze the collected data to determine a reliability of each data, and design a driving mode switching based on the determined result of the reliability of the each data to generate mode switching data and a driving control system switching the driving mode based on the mode switching data provided from the driving mode switching control apparatus.

According to the above, the driving mode switching information are provided by collecting the data of the precise map and the recognition sensor, determining the reliability of the data, and designing the driving mode switching based on the determined result. Accordingly, the driving of the vehicle is efficiently controlled.

### DRAWINGS

The above and other objects, features and advantages of the present disclosure will be more apparent from the following detailed description taken in conjunction with the accompanying drawings:

FIG. 1 is a view illustrating a vehicle system to which a driving mode switching control apparatus of a vehicle is applied according to an exemplary embodiment of the present disclosure;

FIG. 2 is a view illustrating a configuration of a driving mode switching control apparatus of a vehicle according to an exemplary embodiment of the present disclosure;

FIGS. 3A to 3D are views illustrating an operation of determining reliability of a driving mode switching control apparatus of a vehicle according to an exemplary embodiment of the present disclosure;

FIG. 4 is a flowchart illustrating an operation of designing a driving mode switching of a driving mode switching control apparatus of a vehicle according to an exemplary embodiment of the present disclosure;

FIG. 5 is a flowchart illustrating an operation of a driving mode switching control method of a vehicle according to an exemplary embodiment of the present disclosure; and

FIG. 6 is a block diagram illustrating a configuration of a computing system that executes a driving mode switching control method of a vehicle according to an exemplary embodiment of the present disclosure.

### DETAILED DESCRIPTION

Hereinafter, exemplary embodiments of the present disclosure will be described in detail with reference to the accompanying drawings. In the drawings, the same reference numbers will be used throughout to designate the same or equivalent elements. In addition, a detailed description of well-known features or functions will be ruled out in order not to unnecessarily obscure the gist of the present disclosure.

In describing elements of exemplary embodiments of the present disclosure, the terms 1^{st}, 2^{nd}, first, second, A, B, (a), (b), and the like may be used herein. These terms are only used to distinguish one element from another element, but do not limit the corresponding elements irrespective of the order or priority of the corresponding elements. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

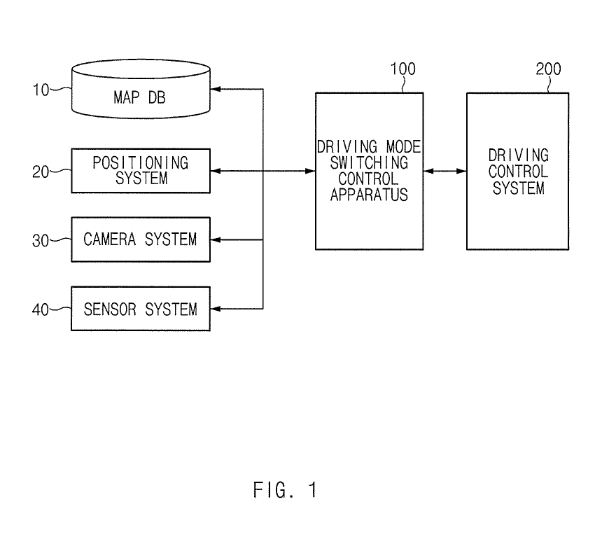

FIG. 1 is a view illustrating a vehicle system to which a driving mode switching control apparatus of a vehicle is applied according to an exemplary embodiment of the present disclosure.

As shown in FIG. 1, the vehicle system according to the present disclosure includes a driving mode switching control apparatus 100 and a driving control system 200.

The driving mode switching control apparatus 100 collects data from one or more systems, e.g., a map database (DB) 10 provided in the vehicle, a positioning system 20, a camera system 30, a sensor system 40, etc., that obtain information around a vehicle.

The map DB 10 may store a precise map, a sensor map, and the like. The precise map is built in advance using a shape of road and topographic information and is able to be used when a position accuracy is ensured through a precise positioning process. In addition, the precise map may be used when the vehicle operates in an autonomous driving mode on highway.

The positioning system 20 may be a system for positioning a precise position of the vehicle and is used to improve the position accuracy of the vehicle.

The camera system 30 may include one or more cameras, processes images taken by the cameras in real time, and obtains information about lane markings, other vehicles around the vehicle, and/or features such as obstacles. The line information obtained by the camera system 30 may be used when the vehicle operates in a traffic-lane following supporting mode.

The sensor system 40 may include a sensor such as an LIDAR, obtains information about features around the vehicle, and provides the obtained information. The LIDAR processes point cloud data detected around the vehicle to obtain information on obstacles and/or topographical features in front of the vehicle. The obstacle information obtained by the sensor system 40 may be used when the vehicle operates in a highway driving supporting mode.

The sensor system 40 may further include a sensor that senses features around the vehicle in addition to the LIDAR.

In addition, the driving mode switching control apparatus 100 may analyze the collected data to determine reliability of each data. In this case, the driving mode switching control apparatus 100 designs a driving mode switching of the vehicle on the basis of the determined reliability of each data, generate driving mode switching data depending on an information of the designed driving mode switching, and provide the driving mode switching data to the driving control system 200.

Accordingly, the driving control system 200 may switch the driving mode of the vehicle based on the mode switching data provided from the driving mode switching control apparatus 100.

The driving mode switching control apparatus 100 according to the present disclosure may be implemented inside the vehicle. In this case, the driving mode switching control apparatus 100 may be integrally fonned with internal controllers of the vehicle or may be connected to the internal controllers of the vehicle by a connection device after being implemented in a separated apparatus.

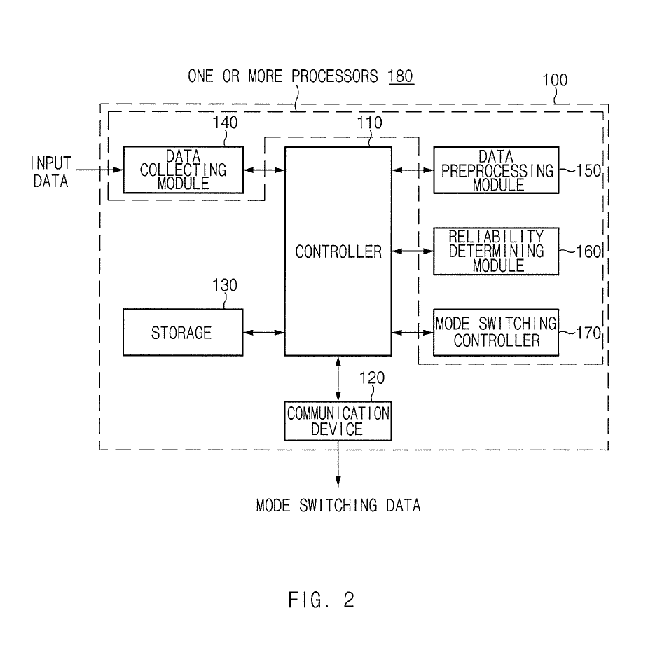

FIG. 2 is a view illustrating a configuration of the driving mode switching control apparatus 100 of the vehicle according to an exemplary embodiment of the present disclosure.

Referring to FIG. 2, the driving mode switching control apparatus 100 may include a controller 110, a communication device 120, a storage 130, and one or more processors 180. The one or more processors 180 each have an associated non-transitory memory storing software instructions which, when executed by the one or more processors 180, provides the functionalities of a data collecting module 140, a data preprocessing module 150, a reliability determining module 160, and a mode switching controller 170. In the present exemplary embodiment, the controller 110, the data collecting module 140, the data preprocessing module 150, the reliability determining module 160, and the mode switching controller 170 of the driving mode switching control apparatus 100 according to the present embodiment may be implemented as at least one processor.

The controller 110 may process signals transmitted between components of the driving mode switching control apparatus 100.

The communication device 120 may include a communication module or transceiver that supports a communication interface with electrical equipments and/or the controllers included in the vehicle. As an example, the communication device 120 may be communicated with the map DB 10 provided in the vehicle, the positioning system 20, the camera system 30, and the sensor system 40 to receive data obtained by each system. In addition, the communication device 120 may be communicated with the driving control system 200 included in the vehicle to transmit the mode switching data to the driving control system 200.

The communication device 120 may include a module supporting a vehicle network communication, such as a controller area network (CAN) communication, a local interconnect network (LIN) communication, a Flex-ray communication, or the like.

The communication device 120 may include a module for a wireless internet access or a module for a short range communication. As a wireless internet technology, the communication module may support communications using various wired or wireless communication standards including wireless LAN (WLAN), wireless broadband (Wibro), Wi-Fi, world interoperability for microwave access (Wimax), and the like. The communication module may additionally or alternatively support communications using short range communication standards including, Bluetooth, ZigBee, ultra wideband (UWB), radio frequency identification (RFID), infrared data association (IrDA), and the like as a short range communication technology.

The storage 130 may store data and/or algorithms and program instructions used to operate the driving mode switching control apparatus 100.

The storage 130 may store the data collected by the data collecting module 140 from the map DB 10, the positioning system 20, the camera system 30, and the sensor system 40. In addition, the storage 130 may store condition information required for the driving mode switching control apparatus 100 to determine the reliability of the collected data. The storage 130 may store machine-readable programming instructions and/or algorithms required for the driving mode switching control apparatus 100 to determine the reliability of the collected data, to design the driving mode switching based on the reliability, and to generate the mode switching data depending on information of the designed driving mode switching.

In the present embodiment, the storage 130 may include one or more storage medium/media including transitory and/or non-transitory storage media, such as a random access memory (RAM), a static random access memory (SRAM), a read-only memory (ROM), a programmable read-only memory (PROM), an electrically erasable programmable read-only memory (EEPROM), etc.

The data collecting module 140 of the one or more processors 180 may request data from the map DB 10, the positioning system 20, the camera system 30, and the sensor system 40, which are connected to the communication device 120, and may collect the data obtained from the map DB 10, the positioning system 20, the camera system 30, and the sensor system 40.

As an example, the data collecting module 140 may collect map data, e.g., the precise map and the sensor map, from the map DB 10. In addition, the data collecting module 140 may collect positioning data from the positioning system 20. In addition, the data collecting module 140 may collect line data from the camera system 30. Further, the data collecting module 140 may collect obstacle data obtained by the sensors such as the LIDAR from the sensor system 40.

The data collected by the data collecting module 140 may be stored in the storage 130 and transmitted to the data preprocessing module 150 through the controller 110. Accordingly, the data preprocessing module 150 of the one or more processors 180 preprocesses the data collected by the data collecting module 140 and transmits the preprocessed data to the reliability determining module 160.

The reliability determining module 160 of the one or more processors 180 may analyze the data, i.e., the map data from the map DB 10, the positioning data from the positioning system 20, the line data from the camera system 30, and the obstacle data from the sensor system 40, which are preprocessed by the data preprocessing module 150, to determine the reliability of each data.

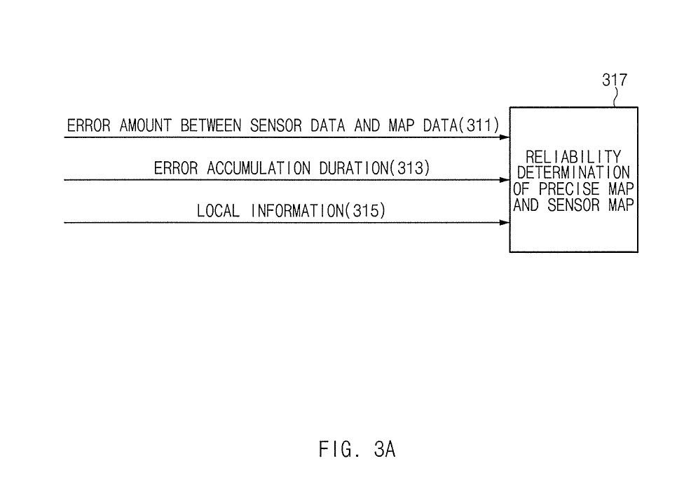

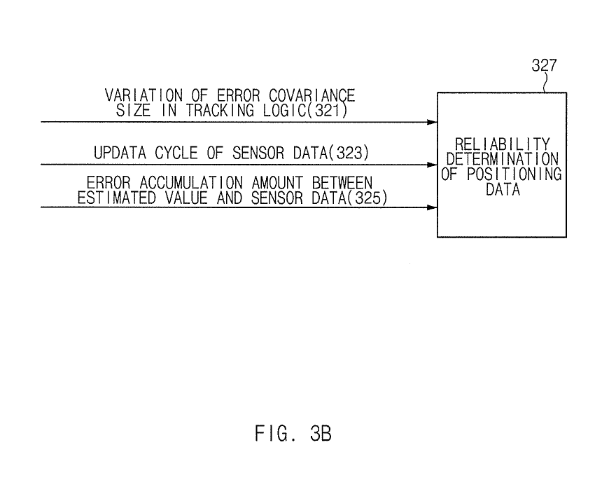

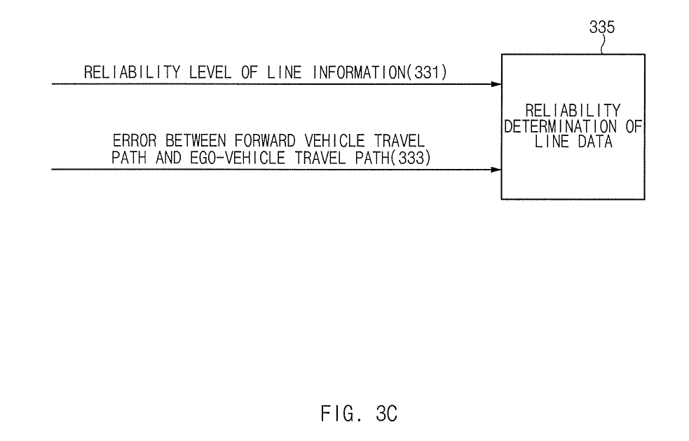

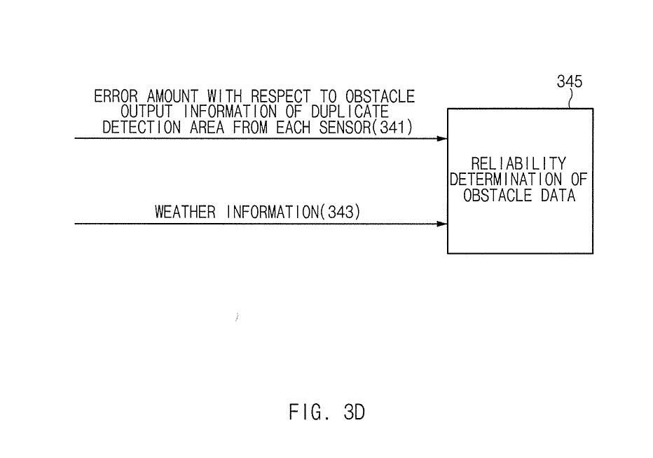

First, as shown in FIG. 3A, the reliability determining module 160 may analyze an error amount 311 in sensor data and the map data, an error accumulation duration 313, and regional information 315 and performs the reliability determination of the precise map and the sensor map 317 based on the analyzed result

In the present embodiment, the reliability determining module 160 may determine that the reliability of the precise map and the sensor map is low as the error amount 311 in the sensor data and the map data becomes larger and the error accumulation duration 313 becomes longer. hi addition, the reliability determining module 160 may quantify a map-matching degree of each region and give a level to the quantified map-matching degree in advance. Accordingly, when the map-matching level corresponding to input regional information is low, the reliability determining module 160 may determine that the reliability of the precise map and the sensor map is low.

In this way, the reliability determining module 160 determines the reliability of the precise map and the sensor map, determines that the reliability is secured when the determined reliability is equal to or greater than a reference value, and determines that the reliability is not sufficiently secured when the determined reliability is smaller than the reference value.

In addition, as shown in FIG. 3B, the reliability determining module 160 analyzes a variation of error covariance size in a tracking logic 321, an update cycle of the sensor data 323, and an error accumulation amount between an estimated value and the sensor data 325, and performs the reliability determination of the positioning data 327 based on the analyzed result.

In the present embodiment, the reliability determining module 160 may determine that the reliability of the positioning data is low as the variation of error covariance size in the tracking logic 321 becomes larger, the update cycle of the sensor data 323 becomes longer, and the error accumulation amount between the estimated value and the sensor data 325 becomes larger.

In this way, the reliability determining module 160 determines the reliability of the positioning data, determines that the reliability is secured when the determined reliability is equal to or greater than a reference value, and determines that the reliability is not sufficiently secured when the determined reliability is smaller than the reference value.

In addition, as shown in FIG. 3C, the reliability determining module 160 may analyze a reliability level of the line information 331 and an error between a forward vehicle travel route and an ego-vehicle travel route in the same traffic lane 333 and performs the reliability determination of the line data 335.

In the present embodiment, the reliability determining module 160 may determine that the reliability of the line data is low as the reliability level of the line information 331 becomes lower and the error between the forward vehicle travel route and the ego-vehicle travel route becomes larger.

In this way, the reliability determining module 160 determines the reliability of the line data, determines that the reliability is secured when the determined reliability is equal to or greater than a reference value, and determines that the reliability is not sufficiently secured when the determined reliability is smaller than the reference value.

In addition, as shown in FIG. 3D, the reliability determining module 160 performs the reliability determination of the obstacle data 345 based on an error amount 341 with respect to obstacle output information of a duplicate detection area from each sensor and weather information 343.

In the present embodiment, the reliability determining module 160 may determine that the reliability of the obstacle data is low as the error amount 341 with respect to obstacle output information of the duplicate detection area between the LIDAR and another sensor becomes larger. In addition, the reliability determining module 160 may quantify a weather degree and give a level to the quantified weather degree in advance. Accordingly, when the level corresponding to input weather information is low, the reliability determining module 160 may determine that the reliability of the obstacle data is low.

In this way, the reliability determining module 160 determines the reliability of the obstacle data, determines that the reliability is secured when the determined reliability is equal to or greater than a reference value, and determines that the reliability is not sufficiently secured when the determined reliability is smaller than the reference value.

The reliability determining module 160 transmits the determined reliability result of each data to the mode switching controller 170.

Then, the mode switching controller 170 of the one or more processors 180 may design the driving mode switching based on the determined result on the reliability of each data and generates the mode switching data depending on the information of the designed driving mode switching.

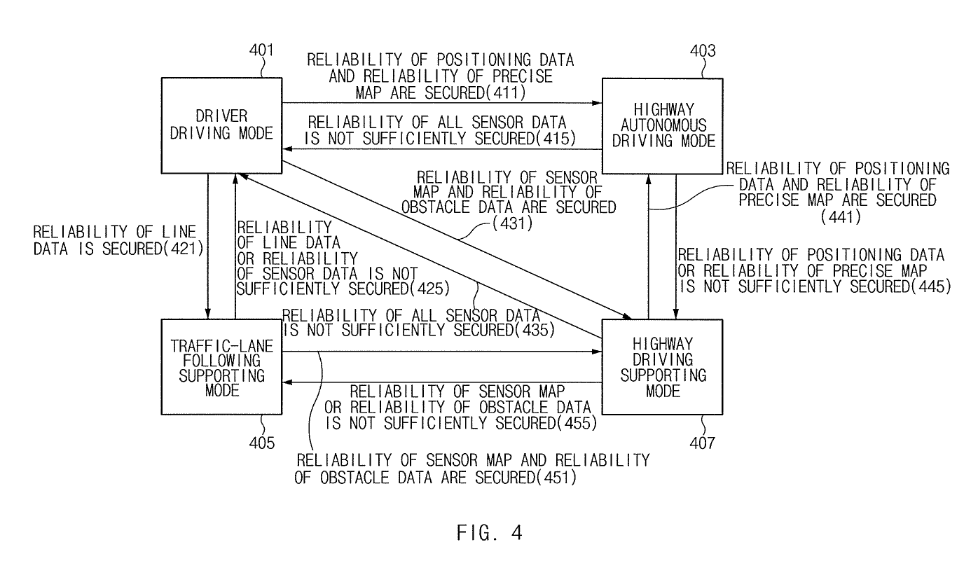

The operation of the driving mode switching control apparatus 100 for designing the driving mode switching will be described with reference to FIG. 4.

Referring to FIG. 4, it is assumed that the driving mode switching according to an exemplary embodiment of the present disclosure is for mode switching between a driver driving mode 401, a highway autonomous driving mode 403, a traffic-lane following supporting mode 405, and a highway driving supporting mode 407.

The mode switching controller 170 may design a mode switching between the highway autonomous driving mode 403, the traffic-lane following supporting mode 405, the highway driving supporting mode 407, and the driver driving mode 401 based on the reliability of the map data, the positioning data, the line data, and the obstacle data, which are provided from the reliability determining module 160.

In the present embodiment, the highway autonomous driving mode 403 operates on a highway, a main lane of motorway, and an entire section of IC/JC/TG and performs an inter-vehicle distance and traffic lane maintenance control function, a traffic lane switching function, an avoidance function, and a function of determining and controlling an automatic entry and exit for IC/JC/TG depending on a route set in a navigation. In this case, the highway autonomous driving mode 403 may operate using the precise map and the positioning data.

Accordingly, the mode switching controller 170 may design the driving mode switching to switch the driving mode of the vehicle to the highway autonomous driving mode 403 as shown by a reference numeral 411 or a reference numeral 441 when it is determined that the reliability of the positioning data and the precise map is secured in the driver driving mode 401 or the highway driving supporting mode 407.

Meanwhile, the mode switching controller 170 may design the driving mode switching to switch the driving mode of the vehicle to the highway driving supporting mode 407 as shown by a reference numeral 445 when it is determined that the reliability of the positioning data or the precise map is not sufficiently secured in the highway autonomous driving mode 403.

In addition, the mode switching controller 170 may design the driving mode switching to switch the driving mode of the vehicle to the driver driving mode 401 as shown by a reference numeral 415 when it is determined that the reliability of the map data, the positioning data, the line data, and the obstacle data is not sufficiently secured in the highway autonomous driving mode 403.

The highway driving supporting mode 407 operates on the highway, the main lane of motorway, and the section of IC/JC and performs the inter-vehicle distance and traffic lane maintenance control function, the traffic lane switching function, the avoidance function, and a setting speed automatic switching function, and a deceleration control function in a speed detecting section. In this case, the highway driving supporting mode 407 may operate using the sensor map and the obstacle data.

Accordingly, the mode switching controller 170 may design the driving mode switching to switch the driving mode of the vehicle to the highway driving supporting mode 407 as shown by a reference numeral 431 or a reference numeral 451 when it is determined that the reliability of the sensor map and the obstacle data is secured in the driver driving mode 401 or the traffic-lane following supporting mode 405. As described above, the mode switching controller 170 may design the driving mode switching to switch the driving mode of the vehicle to the highway driving supporting mode 407 as shown by a reference numeral 445 when it is determined that the reliability of the positioning data or the precise map is not sufficiently secured in the highway autonomous driving mode 403.

Meanwhile, the mode switching controller 170 may design the driving mode switching to switch the driving mode of the vehicle to the traffic-lane following supporting mode 405 as shown by a reference numeral 455 when it is determined that the reliability of the sensor map or the obstacle data is not sufficiently secured in the highway driving supporting mode 407.

In addition, the mode switching controller 170 may design the driving mode switching to switch the driving mode of the vehicle to the driver driving mode 401 as shown by a reference numeral 435 when it is determined that the reliability of the map data, the positioning data, the line data and the obstacle data is not sufficiently secured in the highway driving supporting mode 407.

The traffic-lane following supporting mode 405 operates in the highway and the main lane of the motorway and performs the inter-vehicle distance and the traffic lane maintenance control function. In this case, the traffic-lane following supporting mode may operate using the line data.

Accordingly, the mode switching controller 170 may design the driving mode switching to switch the driving mode of the vehicle to the traffic-lane following supporting mode 405 as shown by a reference numeral 421 when it is determined that the reliability of the line data is secured in the driver driving mode 401. As described above, the mode switching controller 170 may design the driving mode switching to switch the driving mode of the vehicle to the traffic-lane following supporting mode 405 as shown by a reference numeral 455 when it is determined that the reliability of the sensor map or the obstacle data is not sufficiently secured in the highway driving supporting mode 407.

Meanwhile, the mode switching controller 170 may design the driving mode switching to switch the driving mode of the vehicle to the driver driving mode 401 as shown by a reference numeral 425 when it is determined that the reliability of the line data is not sufficiently secured, or the reliability of the map data, the positioning data, the line data and the obstacle data is not sufficiently secured, in the traffic-lane following supporting mode 405.

When the reliability of the map data, the positioning data, the line data, and the obstacle data is secured, the mode switching controller 170 may design the driving mode switching to switch the driving mode of the vehicle to the highway autonomous driving mode 403.

As described above, when the driving mode switching of the vehicle is designed, the mode switching controller 170 generates the mode switching data including the information of the designed driving mode switching. In this case, the mode switching controller 170 transmits the generated mode switching data to the driving control system 200 of the vehicle through the communication device 120.

Accordingly, the driving control system 200 may switch the driving mode of the vehicle depending on the information included in the mode switching data.

The driving mode switching control apparatus 100 according to the present exemplary embodiment as described above may be implemented in one independent hardware including a memory and a processer processing each operation and driven as a hardware while being included in other hardware, e.g., a microprocessor or a general-purpose computer system.

Hereinafter, an operation of the driving mode switching control apparatus 100 for the vehicle, which has the above-mentioned configurations, according to the present disclosure will be described in detail.

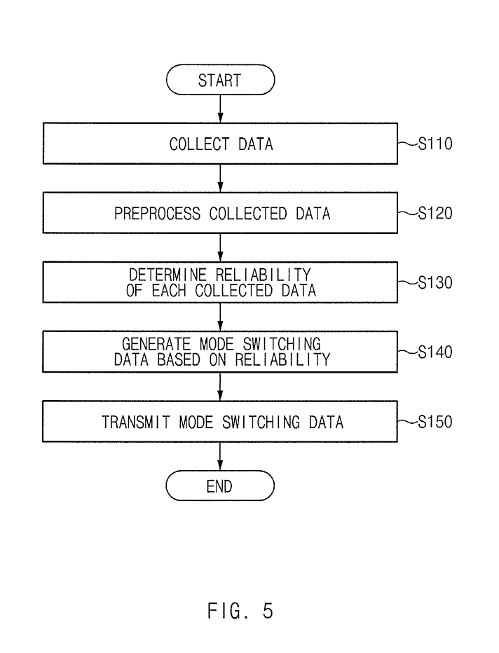

FIG. 5 is a flowchart illustrating an operation of a driving mode switching control method of a vehicle according to an exemplary embodiment of the present disclosure.

Referring to FIG. 5, the driving mode switching control apparatus 100 collects the data from the systems, e.g., the map DB 10 provided in the vehicle, the positioning system 20, the camera system 30, the sensor system 40, etc., that obtain the information around the vehicle (S110). In operation S110, the driving mode switching control apparatus 100 may collect the map data of the precise map and the sensor map from the map DB 10, the positioning data from the positioning system 20, the line data from the camera system 30, and the obstacle data from the sensor system 40.

The driving mode switching control apparatus 100 preprocesses the data collected in operation S110 (S120) and analyzes the preprocessed data to determine the reliability of each data (S130).

Then, the driving mode switching control apparatus 100 designs the driving mode switching for the mode switching based on the determined result of the reliability in operation S130, generates the mode switching data including the information of the designed driving mode switching (S140), and transmits the mode switching data to the driving control system 200 of the vehicle (S150).

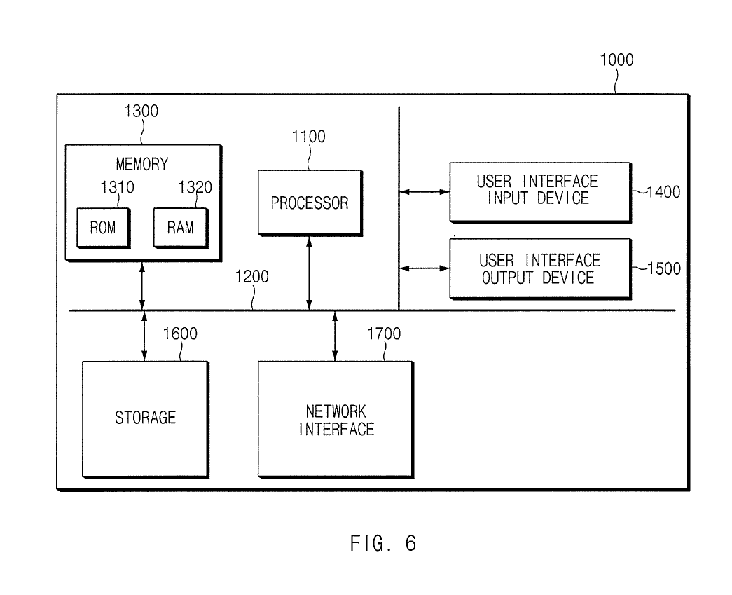

FIG. 6 is a block diagram illustrating a configuration of a computing system that executes the driving mode switching control method of the vehicle according to an exemplary embodiment of the present disclosure.

Referring to FIG. 6, the computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) 1310 and a random access memory (RAM) 1320.

Thus, the operations of the methods or algorithms described in connection with the embodiments disclosed in the specification may be directly implemented with a hardware module, a software module, or combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as a separate component in the user terminal.

While the present disclosure has been described with reference to exemplary embodiments, it will be apparent to those skilled in the art that various changes and modifications may be made without departing from the spirit and scope of the present disclosure.

Therefore, exemplary embodiments of the present disclosure are not limiting, but illustrative, and the spirit and scope of the present disclosure is not limited thereto. The spirit and scope of the present disclosure should be interpreted by the following claims, and it should be interpreted that all technical ideas which are equivalent to the present disclosure are included in the spirit and scope of the present disclosure.

What is claimed is:

1. A driving mode switching control apparatus of a vehicle, comprising one or more processors that are configured to:
collect data from a map DB, a positioning system, a camera system, and a sensor system in the vehicle;
analyze the collected data and to determine a reliability of each data; and
design a driving mode switching of the vehicle based on the determined result of the reliability of the each data and to generate mode switching data including an information of the designed driving mode switching.

2. The driving mode switching control apparatus of the vehicle of claim 1, wherein the one or more processors are further configured to collect map data comprising a precise map and a sensor map, positioning data, line data, and obstacle data from the map DB, the positioning system, the camera system, and the sensor system.

3. The driving mode switching control apparatus of the vehicle of claim 1, wherein the one or more processors are further configured to:
analyze an error amount between sensor data and map data, an error accumulation duration, and regional information; and
determine the reliability of a precise map and a sensor map based on the analyzed result.

4. The driving mode switching control apparatus of the vehicle of claim 1, wherein the one or more processors are further configured to:
analyze a variation of error covariance size in a tracking logic, an update cycle of sensor data, and an error accumulation amount between an estimated value and the sensor data; and
determine the reliability of positioning data based on the analyzed result.

5. The driving mode switching control apparatus of the vehicle of claim 1, wherein the one or more processors are further configured to:
analyze a reliability level of line information and an error between a forward vehicle travel route and an ego-vehicle travel route in a same traffic lane; and
determine the reliability of line data.

6. The driving mode switching control apparatus of the vehicle of claim 1, wherein the one or more processors are further configured to:
determine the reliability of obstacle data based on an error amount with respect to obstacle output information of a duplicate detection area from each sensor of the sensor system and weather information.

7. The driving mode switching control apparatus of the vehicle of claim 1, wherein the one or more processors are further configured to generate the mode switching data for switching a driving mode of the vehicle to a highway autonomous driving mode, a highway driving supporting mode, a traffic-lane following supporting mode, or a driver driving mode depending on the determined result of the reliability of the each data.

8. The driving mode switching control apparatus of the vehicle of claim 7, wherein the one or more processors are further configured to generate the mode switching data for switching the driving mode of the vehicle to the highway autonomous driving mode when the reliability of the each data is equal to or higher than a reference value.

9. The driving mode switching control apparatus of the vehicle of claim 7, wherein the one or more processors are further configured to generate the mode switching data for switching the driving mode of the vehicle to the driver driving mode when the reliability of the each data is lower than a reference value.

10. The driving mode switching control apparatus of the vehicle of claim 1, wherein the one or more processors are further configured to preprocess the collected data.

11. A driving mode switching control method of a vehicle, comprising:
collecting, by one or more processors, data from a map DB, a positioning system, a camera system, and a sensor system in the vehicle;
analyzing, by the one or more processors, the collected data to determine a reliability of each data; and
designing, by the one or more processors, a driving mode switching of the vehicle based on the determined result of the reliability of the each data to generate mode switching data including an information of the designed driving mode switching.

12. The method of claim 11, wherein the collecting of the data comprises collecting map data comprising a precise map and a sensor map, positioning data, line data, and obstacle data from the map DB, the positioning system, the camera system, and the sensor system.

13. The method of claim 11, wherein the determining of the reliability comprises:
analyzing an error amount between sensor data and the map data, an error accumulation duration, and regional information; and
determining the reliability of a precise map and a sensor map based on the analyzed result.

14. The method of claim 11, wherein the determining of the reliability comprises:
analyzing a variation of error covariance size in a tracking logic, an update cycle of sensor data, and an error accumulation amount between an estimated value and the sensor data; and
determining the reliability of positioning data based on the analyzed result.

15. The method of claim 11, wherein the determining of the reliability comprises:
analyzing a reliability level of line information and an error between a forward vehicle travel route and an ego-vehicle travel route in a same traffic lane; and
determining the reliability of line data.

16. The method of claim 11, wherein the determining of the reliability comprises determining the reliability of obstacle data based on an error amount with respect to obstacle output information of a duplicate detection area from each sensor of the sensor system and weather information.

17. The method of claim 11, wherein the generating of the mode switching data comprises generating the mode switching data for switching a driving mode of the vehicle to a highway autonomous driving mode, a highway driving supporting mode, a traffic-lane following supporting mode, or a driver driving mode depending on the determined result of the reliability of the each data.

18. The method of claim 17, wherein the generating of the mode switching data comprises generating the mode switching data for switching the driving mode of the vehicle to the highway autonomous driving mode when the reliability of the each data is equal to or higher than a reference value.

19. The method of claim 17, wherein the generating of the mode switching data comprises generating the mode switching data for switching the driving mode of the vehicle to the driver driving mode when the reliability of the each data is lower than a reference value.

20. A vehicle system comprising:
a driving mode switching control apparatus having one or more processors configured to:
collect map data, positioning data, line data, and obstacle data from a map DB, a positioning system, a camera system, and a sensor system in a vehicle;
analyze the collected data to determine a reliability of each data; and
design a driving mode switching for switching a driving mode based on the determined result of the reliability of the each data to generate mode switching data; and
a driving control system configured to switch the driving mode based on the mode switching data provided from the driving mode switching control apparatus.
